(19) United States
(12) Patent Application Publication
(10) Pub. No.: US 2024/0160508 A1
(43) Pub. Date: May 16, 2024

(54) SYSTEM, DEVICES AND/OR PROCESSES FOR SHARING MACHINE LEARNING MODEL

(71) Applicant: Arm Limited, Cambridge (GB)

(72) Inventors: Eric Van Hensbergen, Austin, TX (US); Joshua Stephan Minor, Austin, TX (US); Alexandre Peixoto Ferreira, Austin, TX (US)

(21) Appl. No.: 18/054,397

(22) Filed: Nov. 10, 2022

(51) Int. Cl. G06F 9/54; G06N 20/00

(52) U.S. Cl. CPC G06F 9/547; G06N 20/00

(57) ABSTRACT

The present disclosure relates generally to systems, devices and/or processes for sharing machine learning models among components of a computing environment.

### BACKGROUND

### Field

The present disclosure relates generally to systems, devices and/or processes for sharing machine learning models among components of a computing environment.

### Information

The Internet is widespread. The World Wide Web or simply the Web, provided by the Internet, is growing rapidly, at least in part, from the large amount of content being added seemingly on a daily basis. A wide variety of content in the form of stored signals, such as, for example, text files, images, audio files, video files, web pages, measurements of physical phenomena, and/or the like may be continually acquired, identified, located, retrieved, collected, stored, communicated, etc. Increasingly, content is being acquired, collected, communicated, etc. by a number of electronic devices, such as, for example, embedded computing devices leveraging existing Internet and/or like infrastructure as part of a so-called “Internet of Things” (IoT), such as via a variety of protocols, domains, and/or applications. IoT may typically comprise a system of interconnected and/or internetworked physical computing devices capable of being identified, such as uniquely via an assigned Internet Protocol (IP) address, for example. Devices, such as IoT-type devices, for example, may include computing resources embedded into hardware so as to facilitate and/or support a device's ability to acquire, collect, process and/or transmit content over one or more communications networks. IoT-type devices, for example, may comprise a wide variety of embedded devices, such as, for example, automobile sensors, biochip transponders, heart monitoring implants, thermostats, kitchen appliances, locks or like fastening devices, solar panel arrays, home gateways, controllers, and/or the like.

Additionally, machine learning (ML), for example, appears to becoming increasingly prevalent throughout the computing industry. For example, it appears to be the expectation among some in the computing industry that a great deal (e.g., most or all) of computation tasks may eventually take on some form of ML solution. To address this surge of interest in ML, more and more systems appear to be including hardware-based ML accelerators and/or the like. Further, software compartmentalization may be increasing throughout the computing industry. For example, containerization of applications and/or services may be increasing. In some instances, challenges may be faced in improving performance, efficiency and/or security, for example, for IoT-type devices in their utilization of ML resources, for example.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a schematic block diagram depicting an embodiment of an example system including one or more server computing devices and/or one or more client computing devices;

FIG. 2 is a schematic block diagram depicting an embodiment of an example client computing device, such as an Internet of Things (IoT) type device;

FIG. 3 depicts a schematic block diagram depicting an example edge computing environment, in accordance with an embodiment;

FIG. 4 is an illustration depicting an example application container, in accordance with an embodiment;

FIG. 5 depicts a schematic block diagram depicting an example edge node, in accordance with an embodiment;

FIG. 6 is an illustration depicting an example application pod and an example inference as a service (IaaS) pod;

FIG. 7 is an illustration depicting an example application pod and an example inference as a service (IaaS) pod, in accordance with an embodiment;

FIG. 8 is an flow diagram depicting an example process for sharing a machine learning model between an application pod and a machine learning inference pod, in accordance with an embodiment; and

FIG. 9 depicts a schematic diagram illustrating an implementation of an example computing and/or communications environment, in accordance with an embodiment.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the patent application, particular context of description and/or usage provides helpful guidance regarding reasonable inferences to be drawn; however, likewise, “in this context” in general without further qualification refers to the context of the present patent application.

As mentioned above, the World Wide Web or simply the Web, provided by the Internet, is growing rapidly, at least in part, from the large amount of content being added seemingly on a daily basis. A wide variety of content in the form of stored signals, such as, for example, text files, images, audio files, video files, web pages, measurements of physical phenomena, and/or the like may be continually acquired, identified, located, retrieved, collected, stored, communicated, etc. Increasingly, content is being acquired, collected, communicated, etc. by a number of electronic devices, such as, for example, embedded computing devices leveraging existing Internet and/or like infrastructure as part of a so-called “Internet of Things” (IoT), such as via a variety of protocols, domains, and/or applications. IoT may typically comprise a system of interconnected and/or internetworked physical computing devices capable of being identified, such as uniquely via an assigned Internet Protocol (IP) address, for example. Devices, such as IoT-type devices, for example, may include computing resources embedded into hardware so as to facilitate and/or support a device's ability to acquire, collect, process and/or transmit content over one or more communications networks. In this context, “IoT-type devices” and/or the like refer to one or more electronic and/or computing devices capable of leveraging existing Internet and/or like infrastructure as part of the IoT, such as via a variety of applicable protocols, domains, applications, etc. In particular implementations, IoT-type devices, for example, may comprise a wide variety of embedded devices, such as, for example, automobile sensors, biochip transponders, heart monitoring implants, thermostats, kitchen appliances, locks or like fastening devices, solar panel arrays, home gateways, controllers, and/or the like. Although embodiments described herein may refer to IoT-type devices, claimed subject matter is not limited in scope in these respects. For example, although IoT-type devices may be described, claimed subject matter is intended to include use of any of a wide range of electronic device types, including a wide range of computing device types.

As also mentioned, machine learning (ML), for example, appears to becoming increasingly prevalent throughout the computing industry. For example, it appears to be the expectation among some in the computing industry that a great deal (e.g., most or all) of computation tasks may eventually take on some form of ML solution. To address this surge of interest in ML, more and more systems appear to be including hardware-based ML accelerators and/or the like. Further, software compartmentalization may be increasing throughout the computing industry. For example, containerization of applications and/or services may be increasing. In some instances, challenges may be faced in improving performance, efficiency and/or security, for example, for IoT-type devices in their utilization of ML resources, for example.

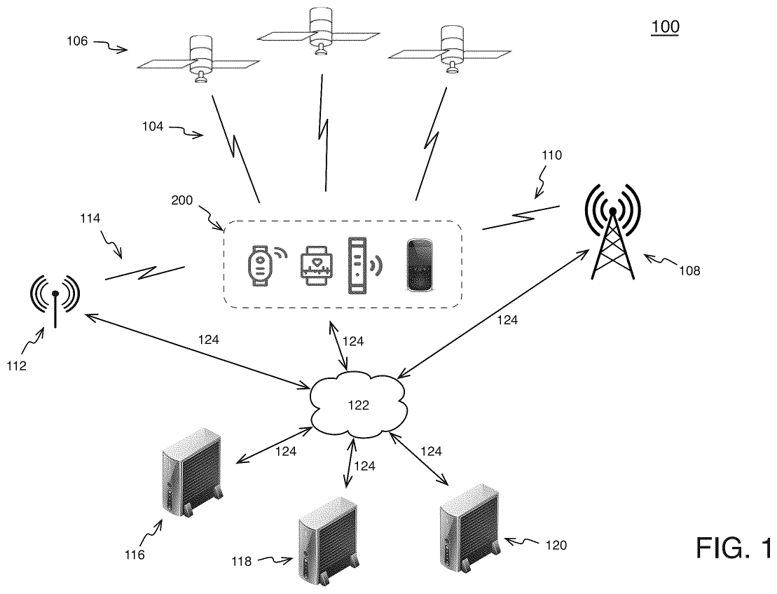

FIG. 1 is a schematic diagram illustrating features associated with an implementation of an example operating environment 100 capable of facilitating and/or supporting one or more operations, processes, techniques, approaches, etc. for sharing machine learning models. It should be appreciated that operating environment 100 is described herein as a non-limiting example that may be implemented, in whole or in part, in a context of various wired and/or wireless communications networks and/or any suitable portion and/or combination of such networks. For example, these or like networks may include one or more public networks (e.g., the Internet, the World Wide Web), private networks (e.g., intranets), wireless wide area networks (VWVAN), wireless local area networks (WLAN, etc.), wireless personal area networks (WPAN), telephone networks, cable television networks, Internet access networks, fiber-optic communication networks, waveguide communication networks and/or the like. It should also be noted that claimed subject matter is not limited to a particular network and/or operating environment. Thus, for a particular implementation, one or more operations, processes, techniques, approaches, etc. for sharing machine learning models may be performed, at least in part, in an indoor environment and/or an outdoor environment, or any combination thereof.

Thus, as illustrated, in a particular implementation, one or more client computing devices 200, such as IoT-type devices, may, for example, receive and/or acquire satellite positioning system (SPS) signals 104 from SPS satellites 106. In some instances, SPS satellites 106 may be from a single global navigation satellite system (GNSS), such as the GPS or Galileo satellite systems, for example. In other instances, SPS satellites 106 may be from multiple GNSS such as, but not limited to, GPS, Galileo, Glonass, or Beidou (Compass) satellite systems, for example. In certain implementations, SPS satellites 1006 may be from any one several regional navigation satellite systems (RNSS) such as, for example, WAAS, EGNOS, QZSS, just to name a few examples.

At times, one or more client computing devices 200 may, for example, transmit wireless signals to and/or receive wireless signals from a suitable wireless communication network. In one example, one or more client computing devices 200 may communicate with a cellular communication network, such as by transmitting wireless signals to and/or receiving wireless signals from one or more wireless transmitters capable of transmitting and/or receiving wireless signals, such as a base station transceiver 108 over a wireless communication link 110, for example. Similarly, one or more client computing devices 200 may transmit wireless signals to and/or receive wireless signals from a local transceiver 112 over a wireless communication link 114, for example. Base station transceiver 108, local transceiver 112, etc. may be of the same or similar type, for example, and/or may represent different types of devices, such as access points, radio beacons, cellular base stations, femtocells, an access transceiver device, or the like, depending on an implementation. Similarly, local transceiver 112 may comprise, for example, a wireless transmitter and/or receiver capable of transmitting and/or receiving wireless signals. For example, at times, wireless transceiver 112 may be capable of transmitting and/or receiving wireless signals from one or more other terrestrial transmitters and/or receivers.

In a particular implementation, local transceiver 112 may, for example, be capable of communicating with one or more client computing devices 200 at a shorter range over wireless communication link 114 than at a range established via base station transceiver 108 over wireless communication link 110. For example, local transceiver 112 may be positioned in an indoor or like environment and/or may provide access to a wireless local area network (WLAN, e.g., IEEE Std. 802.11 network, etc.) and/or wireless personal area network (WPAN, e.g., Bluetooth® network, etc.). In another example implementation, local transceiver 112 may comprise a femtocell and/or picocell capable of facilitating communication via link 114 according to an applicable cellular or like wireless communication protocol. Again, it should be understood that these are merely examples of networks that may communicate with one or more client computing devices 200 over a wireless link, and claimed subject matter is not limited in this respect. For example, in some instances, operating environment 100 may include a larger number of base station transceivers 108, local transceivers 112, networks, terrestrial transmitters and/or receivers, etc.

In an implementation, one or more client computing devices 200, base station transceiver 108, local transceiver 112, etc. may, for example, communicate with one or more servers, referenced herein at 116, 118, and 120, over a network 122, such as via one or more communication links 124. Network 122 may comprise, for example, any combination of wired and/or wireless communication links. In a particular implementation, network 122 may comprise, for example, Internet Protocol (IP)-type infrastructure capable of facilitating or supporting communication between one or more client computing devices 200 and one or more servers 116, 118, 120, etc. via local transceiver 112, base station transceiver 108, directly, etc. In another implementation, network 122 may comprise, for example cellular communication network infrastructure, such as a base station controller and/or master switching center, to facilitate and/or support mobile cellular communication with one or more client computing devices 200. Servers 116, 118 and/or 120 may comprise any suitable servers or combination thereof capable of facilitating or supporting one or more operations, processes, techniques, approaches, etc. discussed herein. For example, servers 116, 118 and/or 120 may comprise one or more update servers, back-end servers, management servers, archive servers, location servers, positioning assistance servers, navigation servers, map servers, crowdsourcing servers, network-related servers, or the like.

Even though a certain number of computing platforms and/or devices are illustrated herein, any number of suitable computing platforms and/or devices may be implemented to facilitate and/or support one or more operations, processes, techniques, approaches, etc. associated with operating environment 100. For example, at times, network 122 may be coupled to one or more wired and/or wireless communication networks (e.g., WLAN, etc.) so as to enhance a coverage area for communications with one or more client computing devices 200, one or more base station transceivers 108, local transceiver 112, servers 116, 118, 120, or the like. In some instances, network 122 may facilitate and/or support femtocell-based operative regions of coverage, for example. Again, these are merely example implementations, and subject matter is not limited in this regard.

In this context, “IoT-type device” and/or the like refers to one or more electronic and/or computing devices capable of leveraging existing Internet or like infrastructure as part of the so-called “Internet of Things” or IoT, such as via a variety of applicable protocols, domains, applications, etc. As was indicated, the IoT is typically a system of interconnected and/or internetworked physical devices in which computing may be embedded into hardware so as to facilitate and/or support devices' ability to acquire, collect, and/or communicate content over one or more communications networks, for example, at times, without human participation and/or interaction. Client computing devices 200, which may, for example, include one or more IoT-type devices, may include a wide variety of stationary and/or mobile devices, such as, for example, automobile sensors, biochip transponders, heart monitoring implants, kitchen appliances, locks or like fastening devices, solar panel arrays, home gateways, smart gauges, smart telephones, cellular telephones, security cameras, wearable devices, thermostats, Global Positioning System (GPS) transceivers, personal digital assistants (PDAs), virtual assistants, laptop computers, notebook computers, personal entertainment systems, tablet devices, personal computers (PCs), personal audio and/or video devices, personal navigation devices, and/or the like, to name a few non-limiting examples. Typically, in this context, a “mobile device” and/or the like refers to an electronic and/or computing device that may from time to time have a position or location that changes. “Stationary device” and/or the like refers to a device that may have a position or location that generally does not change. In some instances, client computing devices 200, such as IoT-type devices, may be capable of being identified, such as uniquely, via an assigned Internet Protocol (IP) address, as one particular example, and/or having an ability to communicate, such as receive and/or transmit electronic content, for example, over one or more wired and/or wireless communications networks.

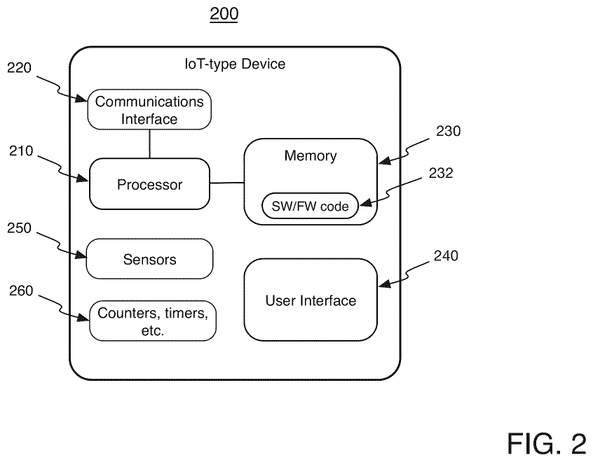

FIG. 2 is an illustration of an embodiment 200 of an example IoT-type device. Of course, subject matter is not limited in scope to the particular configurations and/or arrangements of components depicted and/or described for example devices mentioned herein. In an embodiment, IoT-type device 200 may comprise one or more processors, such as processor 210, and/or may comprise one or more communications interfaces, such as communications interface 220. In an embodiment, one or more communications interfaces, such as communications interface 220, may enable wireless communications between an electronic device, such as IoT-type device 200, and one or more other electronic devices (e.g., IoT-type device, server computing device, etc.). In an embodiment, wireless communications may occur substantially in accordance any of a wide range of communication protocols, such as those mentioned herein, for example.

In a particular implementation, IoT-type device 200 may include a memory, such as memory 230. In a particular implementation, memory 230 may comprise a non-volatile memory, for example. Further, in a particular implementation, a memory, such as memory 230, may have stored therein executable instructions, such as for one or more operating systems, communications protocols, and/or applications, for example. A memory, such as 230, may further store particular instructions, such as software and/or firmware code 232, that may be updated from time to time, for example. Further, in a particular implementation, a client computing device, such as IoT-type device 200, may comprise a user interface, such as user interface 240, and/or one or more sensors, such as one or more sensors 250. As utilized herein, “sensors” and/or the like refer to a device and/or component that may respond to physical stimulus, such as, for example, heat, light, sound pressure, magnetism, particular motions, etc., and/or that may generate one or more signals and/or states in response to physical stimulus. Example sensors may include, but are not limited to, one or more accelerometers, gyroscopes, thermometers, magnetometers, barometers, light sensors, proximity sensors, hear-rate monitors, perspiration sensors, hydration sensors, breath sensors, cameras, microphones, etc., and/or any combination thereof.

In particular implementations, IoT-type device 200 may include one or more timers and/or counters and/or like circuits, such as circuitry 260, for example. In an embodiment, one or more timers and/or counters and/or the like may track one or more aspects of device performance and/or operation.

Although FIG. 2 depicts a particular example implementation of a client computing device, such as IoT-type device 200, other embodiments and/or implementations may include other types, configurations, arrangements, etc. of electronic and/or computing devices. As mentioned, example types of devices may include, but are not limited to, automobile sensors, biochip transponders, heart monitoring implants, kitchen appliances, locks or like fastening devices, solar panel arrays, home gateways, smart gauges, smart telephones, cellular telephones, security cameras, wearable devices, thermostats, Global Positioning System (GPS) transceivers, personal digital assistants (PDAs), virtual assistants, laptop computers, notebook computers, personal entertainment systems, tablet devices, personal computers (PCs), personal audio and/or video devices, personal navigation devices, or any combination of the foregoing.

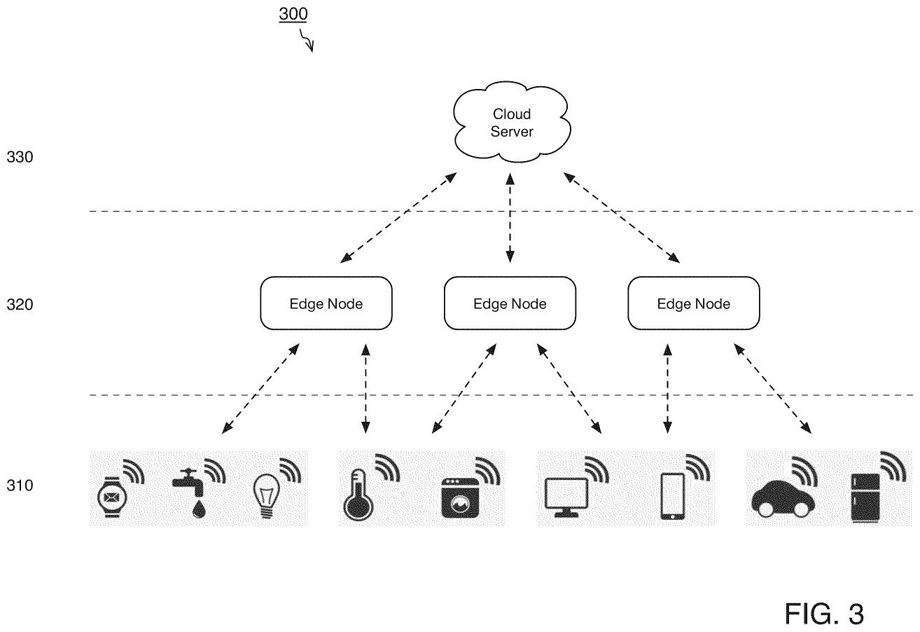

FIG. 3 depicts a schematic block diagram depicting an example edge computing environment 300, in accordance with an embodiment. Generally, “edge computing” and/or the like refers to a distributed computing approach that may bring computation and/or content storage closer to sources of the content. Stated otherwise, edge computing may comprise computing that takes place at or near the physical location of the source(s) of content. Example sources of content (e.g., signals and/or signal packets) may include sensors, such as example sensors associated with IoT-type devices mentioned above. By locating computation and/or storage resources physically closer to content sources, it is expected that latencies may be improved and/or that bandwidth utilization may be reduced. Reliability may also be improved in at least some circumstances.

For one example of an edge computing use case, consider a manufacturing plant. On a factory floor, a relatively large number of IoT-type sensors may generate a stream of signals and/or signal packets that may be utilized to prevent breakdowns and/or to otherwise improve operations. In such circumstances, it may be quicker and perhaps less costly to process the generated stream of signals and/or signal packets utilizing computational resources physically located close to the sensors rather than transmit the stream of signals and/or signal packets to a remote data center, for example.

Another example use cases may include autonomous vehicles. Such vehicles tend to generate relatively large amounts of content (e.g., signals and/or signal packets) from the many sensors onboard. Due at least in part to the relatively large amount of content generated relatively continuously, autonomous vehicles may process sensor signals and/or signal packets onboard rather than transmit the signals and/or signal packets to a remote computing resource. By processing such content onboard, autonomous vehicles may avoid the relatively longer latencies that would otherwise be experienced as a result of relying on transmissions to and from a remote computing resource.

Even with the advantages that may be had in placing computing resources at or near the sources of sensor signals and/or signal packets, for example, it may be desirable to link the various sources (e.g., IoT-type devices) to a centralized computing platform so that the sources may receive software updates, share particular content, offload particular computational tasks to other systems, etc. For example, computing environment 300 depicted in FIG. 3 may include a device layer 310 comprising a number of IoT-type devices. In implementations, the devices of layer 310 may have at least some characteristics similar to those of IoT-type device 200 discussed above.

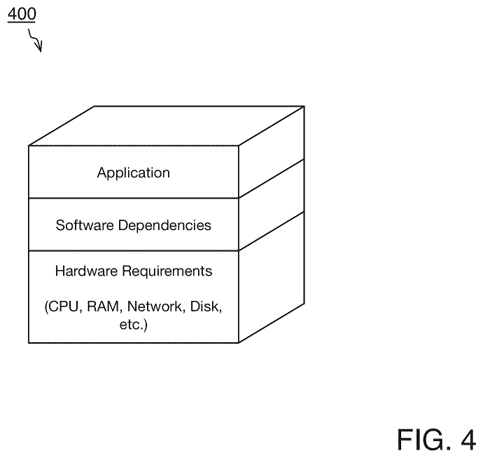

In implementations, example computing environment 300 may further include an edge node layer 320. In implementations, IoT-type devices of layer 310 may be linked via wired and/or wireless interconnect technologies to one or more edge nodes, wherein the edge nodes may be physically located relatively close to the IoT-type devices of layer 310. Of course, various implementations may place edge nodes at various distances from content sources (e.g., IoT-type devices, sensors, client computing devices, etc.) and subject matter is not limited in scope in these respects. An example edge node 400 is discussed more fully below in connection with FIG. 4.

As further depicted in FIG. 3, example computing environment 300 may include a cloud server layer 330. For example, the edge nodes of layer 320 may be linked via wired and/or wireless interconnect technologies to a remote computing resource, such as a cloud server. Of course, a cloud server may comprise one or more computing devices that may not be physically located at or near the edge nodes. For example, a cloud server may comprise a number of computing devices that may be located at one or more locations. Generally, a cloud server may comprise a centralized computing resource hosted over a network, such as the Internet, that may be accessed by a number of network devices including, for example, client computing devices. In some circumstances, a cloud server may be accessed by a great number of computing devices. Of course, for example computing environment 300, the cloud server of layer 330 may be linked to the edge nodes of layer 320. Although the edge nodes of layer 320 may perform computational tasks related to signals and/or signal packets obtained from IoT-type devices of layer 310, the edge nodes of layer 320 may at times task a cloud server, such as the cloud server depicted at layer 330, for example, to perform computational tasks.

As mentioned above, machine learning (ML) is playing an ever-larger role in the computing industry. A great number of example ML use cases may involve ML inference operations performed on sensor content (e.g., signals and/or signal packets) obtained from IoT-type devices. Some organizations may provide computing services referred to ML Inference as a Service (MLIaaS) to address the need for ML computational resources. MLIaaS services may be provided as cloud-based services (e.g., computational tasks performed at one or more cloud servers), as edge-based services (e.g., computational tasks performed at one or more edge nodes) and/or as a combination of cloud-based and edge-based approaches. In implementations, MLIaaS and/or other ML-type computing resource providers may operate in conjunction with containerized software application environments (software containers and/or pods are discussed more fully below). For example, MLIaaS systems such as Nvidia Triton and/or Tensorflow Serving may manage access to ML execution resources in infrastructure environments and may be utilized to manage multi-tenant access to ML execution resources.

FIG. 4 is an illustration depicting an example application container 400. As utilized herein, “application container” and/or the like refers to signals and/or states representative of a particular collection including a software application, software dependencies for the software application and hardware specifications pertaining to the software application. Further, “pod” and/or the like refers to a group of one or more application containers having shared storage and/or network resources and a specification pertaining to how to run the containers. Pods are discussed more fully below.

In implementations, an application container, such as example application container 400, may comprise a stand-alone, all-in one package for a software application. As mentioned, software containers may include the software application itself (e.g., application binaries) along with software dependencies and hardware specification for executing the application. In implementations, an application container, such as application container 400, may be dropped into a system and may be run using local hardware and operating system. Because an application container includes software dependencies, the application container may function the same when deployed on a laptop computing device, a server computing device, on a virtual machine, on a cloud-based server, or any other compatible system. Also, for example, because an application container may comprise a self-contained package, the application container may relatively easily be moved to different system and/or may relatively easily be shared among various systems.

As will be discussed more fully below, application containers may lend themselves to advantageous utilization in secure multi-tenant environments. For example, because each application container creates an isolated environment for its application, resources allocated to it may be considered as an entire machine. Other copies of the same container or other containers are unaware of each other. As a result, multiple different applications can be executed concurrently on the same computing device (e.g., server, node, etc.). Individual applications may utilize only the resources allocated to it (e.g., as specified by “hardware specifications” included in the application container). When a particular application has completed, the allocated resources may be released back to the system, for example.

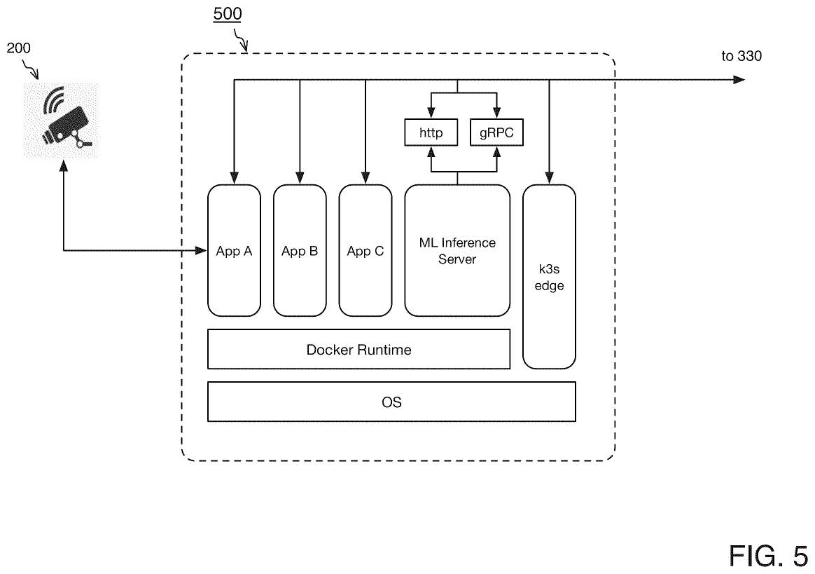

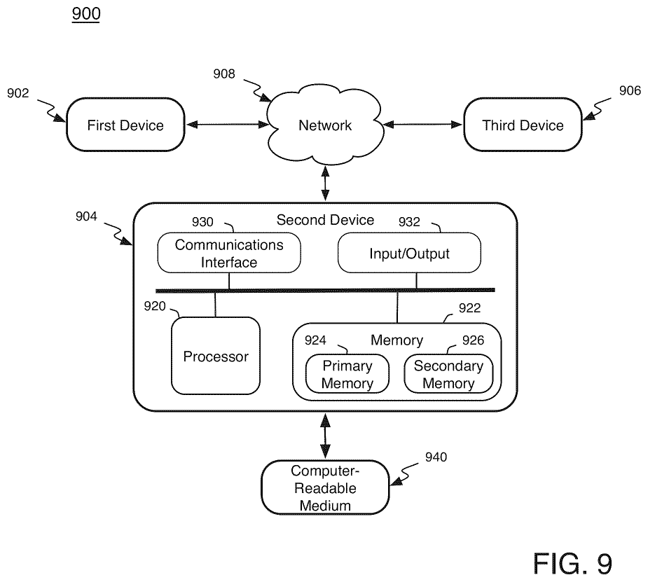

FIG. 5 depicts a schematic block diagram depicting an example edge node 500, in accordance with an embodiment. In implementations, an edge node, such as edge node 500, may include computing resources such as one or more processors, one or more memory devices, one or more communication interfaces, etc. For example, an edge node may include at least some of the characteristics of example computing device 904 discussed below in connection with FIG. 9. At times, edge nodes may also be referred to as edge servers. That is, the terms “edge node” and “edge server” may be utilized interchangeably.

As mentioned above, an edge node may comprise a computing device located at or relatively near one or more sources of sensor content. For example, as depicted in FIG. 3, an edge node may be physically located at or near one or more IoT-type devices. In an implementation, edge node may run an operating system. For example, edge node 500 may run a Yocto/Linux-based operating system (e.g., developed by the Linux Foundation) and/or a Raspberry Pi operating system (e.g., release Apr. 4, 2022, developed by the Raspberry Pi Foundation), to name merely two non-limiting examples.

As also depicted in FIG. 5, edge node 500 may also run a Docker runtime software component (e.g., developed by Docker, Inc, released Mar. 20, 2013). Generally, Docker may comprise an operating system for application containers. Docker may provide a standardized way to execute containerized software applications, for example. Of course, although Docker is specifically mentioned herein, other runtime software components and/or operating systems may be utilized and subject matter is not limited in scope in these respects. Further, for example, edge node 500 may run a K3s software agent (e.g., developed by Cloud Native Computing Foundation) to help facilitate application container execution in a Kubernetes-based edge computing environment. Kubernetes is an open-source container orchestration engine, hosted by Cloud Native Computing Foundation, for automating deployment, scaling and/or management of containerized applications. Of course, although Kubernetes is mentioned herein, subject matter is not limited in scope in these respects.

Returning to example edge node 500, one or more application containers may be executed. For example, App A, App B and App C containers are depicted. Also depicted is a machine learning (ML) inference server (e.g., ML inference application container). In implementations, the ML inference server may perform, at least in part, ML inference operations on behalf of client computing devices, such as IoT-type device 200, for example, based at least in part on one or more ML models, for example.

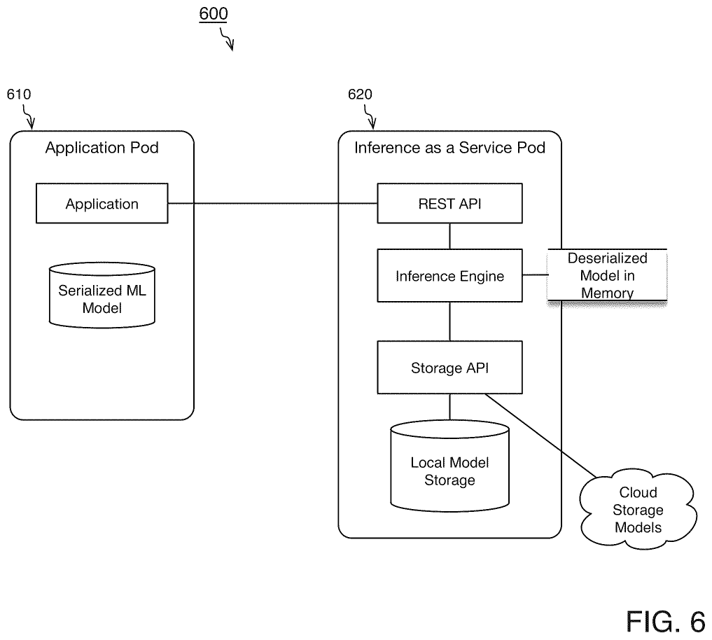

FIG. 6 relates generally to an example approach to interactions between application pods (e.g., including a software application container and an ML model) run on client computing devices, such as IoT-type device 200, and Inference as a Service (IaaS) pods run on an edge node, such as edge node 500. As mentioned, “pod” and/or the like refers to a group of one or more application containers having shared storage and/or network resources and a specification pertaining to how to run the containers.

FIG. 6 is an illustration depicting an example application pod 610 and an example ML Inference as a service (MLIaaS) pod 620. In implementations, pod 610 may be executed at a client computing device, such as IoT-type device 200, and pod 620 may be executed by an edge node, such as edge node 500, for example. For example, application pod 610 may include an application container and may also include an ML model. Additionally, for example, IaaS pod 620 may include an inference engine application and may also include a REST application programming interface (API) and/or a storage API. Further, for example, IaaS pod 620 may include a local ML model storage structure.

In some circumstances, application pod 610, executed at IoT-type device 200, for example, may establish a connection with MLIaaS pod 620 executed at edge node 500. For example, a connection may be established at least in part in accordance with a hypertext transport protocol (HTTP) and/or at least in part in accordance with a remote procedure call framework (e.g., gPRC developed by Google, release 1.45.0, Mar. 19, 2022).

For the example approach depicted in FIG. 6, responsive at least in part to establishing the connection, the serialized ML model of application pod 610 may be copied from application pod 610 executed at IoT-type device 200 to the local model storage structure of MLIaaS pod 620 at edge node 500, for example. Also, for the example approach depicted in FIG. 6, prior to performing an inference operation based on the ML model provided by application pod 610, the ML model may be deserialized and placed in an inference engine memory. Thus, for example, copies of the serialized ML model are stored in application pod 610 at IoT-type device 200 and also in local model storage for MLIaaS pod 620 at edge node 500 and a deserialized version of the ML model is also stored in the inference engine memory at edge node 500. Also, for some implementations, application pod 610 may be executed at edge node 500. In such example circumstances, several copies of an ML model may be stored at edge node 500 (e.g., serialized version stored in application pod 610, serialized version in local storage for the MLIaaS pod 620 and also deserialized version stored in memory). Because ML models may be relatively very large in some circumstances, storing several copies of an ML model at a relatively resource-constrained edge node may pose significant challenges and/or problems with respect to performance, efficiency, feasibility, etc. For example, it may simply not be feasible to perform inference operations on the edge for at least some ML model types utilizing the example approach depicted in FIG. 6.

Also, for example, in multi-tenant systems, because the ML model has been copied into local model storage for MLIaaS pod 620 and/or because multiple software applications may access and/or utilize MLIaaS pod 620 for ML inference operations, the copied ML model may be vulnerable from a security standpoint. For example, for circumstances in which multiple ML models have been deserialized and stored at an edge node memory, multiple software applications pertaining to the multiple ML models may have visibility into each other's ML models, for example. Providing suitable security to prevent various applications from accessing various ML models stored in memory may prove challenging in relatively resource-constrained systems, such as edge node 500, for example.

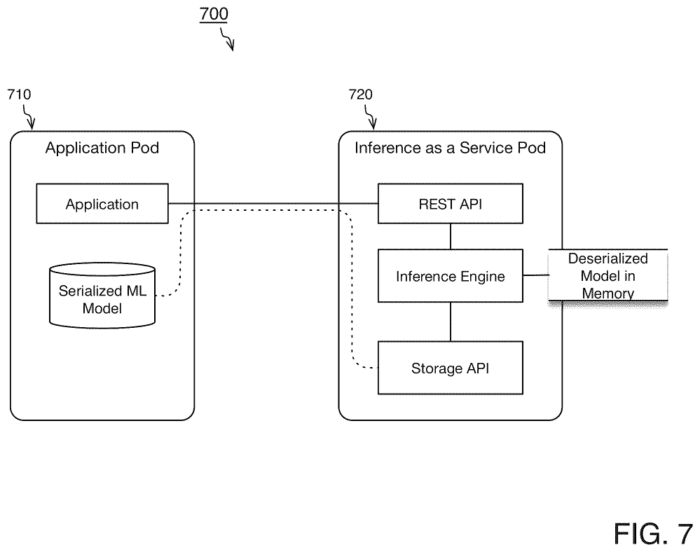

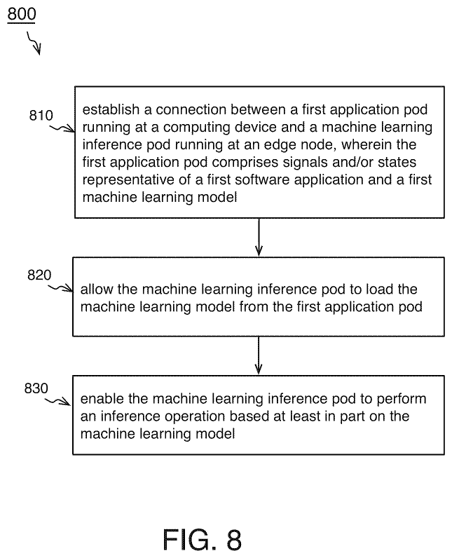

FIG. 7 and FIG. 8, described below, depict example embodiments directed to addressing, at least in part, the significant challenges and/or problems mentioned above in connection with other approaches, such as the example approach depicted in FIG. 6. For example, embodiments described herein, such as in connection with FIG. 7, for example, may relate to processes, devices, systems, etc. to allow client applications running in application containers to publish their associated ML models to MLIaaS containers without copying the ML models to the MLIaaS container storage and/or without using other cloud volume services, for example. This example characteristic of embodiments described herein may allow a ML model to be shipped with an application container instead of being handled separately. This may prove advantageous when utilized in more modern deployment infrastructure (e.g., Kubernetes) and/or in edge computing environments (e.g., see FIG. 3) that may locate computing resources more physically distant or even disconnected from cloud storage resources, for example.

FIG. 7 is an illustration depicting an example application pod 710 running at IoT-type device 200 and/or at edge node 500, for example, and an example ML inference as a service (MLIaaS) pod 720 running at edge node 500, for example, in accordance with an embodiment. In implementations, application pod 710 may establish a connection with MLIaaS pod 720. For example, a connection may be established at least in part in accordance with HTTP and/or at least in part in accordance with remote procedure call framework gPRC. Of course, subject matter is not limited in scope to these particular example connection approaches and/or protocols.

Responsive at least in part to establishing the connection, rather than copying a serialized ML model to the local model storage structure of MLIaaS pod 720 as was done in the example approach described above in connection with FIG. 6, MLIaaS pod 720 may be allowed to load the serialized ML model of application pod 710. For example, MLIaaS pod 720 may be allowed to access a filesystem of application pod 710 over the same connection previously initiated by application pod 710. In implementations, MLIaaS pod 720 may load the serialized ML model directly from application pod 710 via a reverse mount of the application pod's namespace, for example, although subject matter is not limited in scope in this respect.

In implementations, the software application of application pod 710 may initiate the connection to MLIaaS pod 720, for example, and/or may serve access to a local namespace for application pod 710 over the initiated connection. In implementations, access may be granted by way of library code (e.g., executable instructions) that may be implemented in the MLIaaS inference engine to allow the inference engine to obtain a ML model via a link provided by application pod 710 upon connection initiation. In implementations, the library code may be compatible with and/or compliant with a 9P protocol (e.g., Plan 9 Filesystem Protocol developed by Bell Labs), although subject matter is not limited in scope in this respect.

“Reverse mount” and/or the like refers to a sending component, such as an application pod, providing content (e.g., signals and/or signal packets) to a receiving component, such as a ML inference engine running at an edge node, to enable the receiving component to load particular content, such as a serialized ML model, directly from the sending component via access to the sending component's local namespace.

In an implementation, selective access granted to MLIaaS pod 720 to application pod 710's local namespace may enable MLIaaS inference engine to directly load the ML model from application pod 710. Further, in an implementation, the ML model is deserialized by the inference engine directly from application pod 710 to inference engine memory without copying the ML model to local model storage or to cloud storage. Also, in implementations, a hashing algorithm may be utilized prior to deserializing the ML model to ensure that the ML model hasn't already been deserialized into the inference engine memory. For example, in some circumstances, a deserialized ML model may stay resident in inference engine memory to support tenant sharing of models and/or caching of hot models, in implementations. In implementations, utilization of a hashing algorithm may prevent duplicate ML models (e.g., deserialized) from being loaded into inference engine memory. For example, a hashing algorithm may be utilized to ensure uniqueness for ML models loaded into memory (e.g., inference engine memory).

Although the example approach described in connection with FIG. 7 may be advantageously utilized in connection with Kubernetes environments on the edge, other implementations are possible with other container technologies and/or approaches, other virtual machine technologies and/or approaches and/or distributed clusters of nodes, to name a few non-limiting examples.

In implementations, MLIaaS pod 720 may provide application pod 710 with ML inference operation results via the previously established connection.

“Serialized,” “serialization” and/or the like refers to a process of translating a data structure and/or object state, for example, into a format that can be stored and/or transmitted and reconstructed later. “Deserialized,” “deserialization” and/or the like refers to a process of reconstructing a previously serialized data structure or object state, for example, to instantiate the object for consumption, execution, etc.

FIG. 8 is a flow diagram illustrating an embodiment of an example process 800 for sharing a machine learning model between an application pod running at a client computing device, such as an IoT-type device, and a machine learning inference pod running at an edge node, for example. Embodiments may include all of the operations described, fewer than the operations described, and/or more than the operations described for example process 800. Likewise, it should be noted that content acquired or produced, such as, for example, input signals, output signals, operations, results, etc. associated with the example provided may be represented via one or more analog and/or digital signals and/or signal packets. It should also be appreciated that even though one or more operations, processes, techniques, approaches, etc. are illustrated or described concurrently or with respect to a certain sequence, other sequences or concurrent operations, processes, techniques, approaches, etc. may be employed. Further, it should be noted that operations, processes, techniques, approaches, etc. may be implemented, performed, etc. by any combination of hardware, firmware and/or software. In addition, although the description below references particular aspects and/or features illustrated in certain other figures, one or more operations, processes, techniques, approaches, etc. may be performed with other aspects and/or features.

As depicted at block 810, example process 800 includes establishing, utilizing a processor of a computing device (e.g., IoT-type device 200), a connection between a first application pod running at the computing device and a machine learning inference pod running at an edge node (e.g., edge node 500), wherein the first application pod comprises signals and/or states representative of a first software application and a machine learning model, for example. In implementations, example process 800 also includes allowing the machine learning inference pod to load the machine learning model from the first application pod, as depicted at block 820, and to enable the machine learning inference pod to perform an inference operation based at least in part on the machine learning model, as depicted at block 830.

In implementations, allowing the machine learning inference pod to load the machine learning model from the first application pod may include allowing the machine learning inference pod to directly load the machine learning model over a reverse mount of the first application pod's namespace.

In implementations, reverse mounting the first machine learning model to the machine learning inference pod may include the first application pod providing the machine learning inference pod one or more parameters to enable the machine learning inference pod to access to a local file namespace for the first application pod via the established connection.

Further, in implementations, allowing the machine learning inference pod to load the machine learning model from the first application pod may include allowing the machine learning inference pod running at the edge node to access a local namespace for the first application pod. Additionally, for example, the machine learning model may comprise a serialized machine learning model and, to load the machine learning model from the first application pod, the machine learning inference pod may deserialize the machine learning model directly from the first application pod and may store the deserialized machine learning model in a memory allocated to the machine learning inference pod without storing the machine learning model in a cloud storage and without storing the machine learning model in a local model storage.

In implementations, the machine learning inference pod may include one or more application programming interfaces and an inference engine. In implementations, the machine learning inference pod, at least in part via the edge node, may perform the first inference operation at least in part by executing the inference engine. In other implementations, the edge node may execute the inference engine at least in part by establishing a connection with a cloud-based inference service to have the first inference operation performed, at least in part, by the cloud-based inference service.

Further, in implementations, establishing the connection between the first application pod and the machine learning inference pod may include establishing the connection at least in part in accordance with a hypertext transport protocol (HTTP). In other implementations, establishing the connection between the first application pod and the machine learning inference pod may include establishing the connection at least in part in accordance with a remote procedure call framework.

Additionally, example process 800 may include establishing one or more additional connections between one or more additional application pods and the machine learning pod and allowing the machine learning pod to directly access the one or more additional machine learning models pertaining respectively to the one or more additional application pods, wherein the machine learning inference pod to prevent the first software application from accessing the one or more additional machine learning models and also to prevent one or more additional software applications pertaining respectively to the one or more additional application pods from accessing the machine learning model of the first application pod.

In the context of the present patent application, the term “connection,” the term “component” and/or similar terms are intended to be physical, but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, particularly a wireless network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, “coupled” is also used to mean that two or more tangible components and/or the like are not necessarily tangibly in direct physical contact, but are able to co-operate, liaise, and/or interact, such as, for example, by being “optically coupled.” Likewise, the term “coupled” is also understood to mean indirectly connected. It is further noted, in the context of the present patent application, since memory, such as a memory component and/or memory states, is intended to be non-transitory, the term physical, at least if used in relation to memory necessarily implies that such memory components and/or memory states, continuing with the example, are tangible.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

A “signal measurement” and/or a “signal measurement vector” may be referred to respectively as a “random measurement” and/or a “random vector,” such that the term “random” may be understood in context with respect to the fields of probability, random variables and/or stochastic processes. A random vector may be generated by having measurement signal components comprising one or more random variables. Random variables may comprise signal value measurements, which may, for example, be specified in a space of outcomes. Thus, in some contexts, a probability (e.g., likelihood) may be assigned to outcomes, as often may be used in connection with approaches employing probability and/or statistics. In other contexts, a random variable may be substantially in accordance with a measurement comprising a deterministic measurement value or, perhaps, an average measurement component plus random variation about a measurement average. The terms “measurement vector,” “random vector,” and/or “vector” are used throughout this document interchangeably. In an embodiment, a random vector, or portion thereof, comprising one or more measurement vectors may uniquely be associated with a distribution of scalar numerical values, such as random scalar numerical values (e.g., signal values and/or signal sample values), for example. Thus, it is understood, of course, that a distribution of scalar numerical values, for example, without loss of generality, substantially in accordance with the foregoing description and/or later description, is related to physical measurements, and is likewise understood to exist as physical signals and/or physical signal samples.

The terms “correspond”, “reference”, “associate”, and/or similar terms relate to signals, signal samples and/or states, e.g., components of a signal measurement vector, which may be stored in memory and/or employed with operations to generate results, depending, at least in part, on the above-mentioned, signal samples and/or signal sample states. For example, a signal sample measurement vector may be stored in a memory location and further referenced wherein such a reference may be embodied and/or described as a stored relationship. A stored relationship may be employed by associating (e.g., relating) one or more memory addresses to one or more another memory addresses, for example, and may facilitate an operation, involving, at least in part, a combination of signal samples and/or states stored in memory, such as for processing by a processor and/or similar device, for example. Thus, in a particular context, “associating,” “referencing,” and/or “corresponding” may, for example, refer to an executable process of accessing memory contents of two or more memory locations, e.g., to facilitate execution of one or more operations among signal samples and/or states, wherein one or more results of the one or more operations may likewise be employed for additional processing, such as in other operations, or may be stored in the same or other memory locations, as may, for example, be directed by executable instructions. Furthermore, terms “fetching” and “reading” or “storing” and “writing” are to be understood as interchangeable terms for the respective operations, e.g., a result may be fetched (or read) from a memory location; likewise, a result may be stored in (or written to) a memory location.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be substantially present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present patent application merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

With advances in technology, it has become more typical to employ distributed computing and/or communication approaches in which portions of a process, such as signal processing of signal samples, for example, may be allocated among various devices, including one or more client devices and/or one or more server devices, via a computing and/or communications network, for example. A network may comprise two or more devices, such as network devices and/or computing devices, and/or may couple devices, such as network devices and/or computing devices, so that signal communications, such as in the form of signal packets and/or signal frames (e.g., comprising one or more signal samples), for example, may be exchanged, such as between a server device and/or a client device, as well as other types of devices, including between wired and/or wireless devices coupled via a wired and/or wireless network, for example.

An example of a distributed computing system comprises the so-called Hadoop distributed computing system, which employs a map-reduce type of architecture. In the context of the present patent application, the terms map-reduce architecture and/or similar terms are intended to refer to a distributed computing system implementation and/or embodiment for processing and/or for generating larger sets of signal samples employing map and/or reduce operations for a parallel, distributed process performed over a network of devices. A map operation and/or similar terms refer to processing of signals (e.g., signal samples) to generate one or more key-value pairs and to distribute the one or more pairs to one or more devices of the system (e.g., network). A reduce operation and/or similar terms refer to processing of signals (e.g., signal samples) via a summary operation (e.g., such as counting the number of students in a queue, yielding name frequencies, etc.). A system may employ such an architecture, such as by marshaling distributed server devices, executing various tasks in parallel, and/or managing communications, such as signal transfers, between various parts of the system (e.g., network), in an embodiment. As mentioned, one non-limiting, but well-known, example comprises the Hadoop distributed computing system. It refers to an open source implementation and/or embodiment of a map-reduce type architecture (available from the Apache Software Foundation, 1901 Munsey Drive, Forrest Hill, MD, 21050-2747), but may include other aspects, such as the Hadoop distributed file system (HDFS) (available from the Apache Software Foundation, 1901 Munsey Drive, Forrest Hill, MD, 21050-2747). In general, therefore, “Hadoop” and/or similar terms (e.g., “Hadoop-type,” etc.) refer to an implementation and/or embodiment of a scheduler for executing larger processing jobs using a map-reduce architecture over a distributed system. Furthermore, in the context of the present patent application, use of the term “Hadoop” is intended to include versions, presently known and/or to be later developed.

In the context of the present patent application, the term network device refers to any device capable of communicating via and/or as part of a network and may comprise a computing device. While network devices may be capable of communicating signals (e.g., signal packets and/or frames), such as via a wired and/or wireless network, they may also be capable of performing operations associated with a computing device, such as arithmetic and/or logic operations, processing and/or storing operations (e.g., storing signal samples), such as in memory as tangible, physical memory states, and/or may, for example, operate as a server device and/or a client device in various embodiments. Network devices capable of operating as a server device, a client device and/or otherwise, may include, as examples, dedicated rack-mounted servers, desktop computers, laptop computers, set top boxes, tablets, netbooks, smart phones, wearable devices, integrated devices combining two or more features of the foregoing devices, and/or the like, or any combination thereof. As mentioned, signal packets and/or frames, for example, may be exchanged, such as between a server device and/or a client device, as well as other types of devices, including between wired and/or wireless devices coupled via a wired and/or wireless network, for example, or any combination thereof. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description, a network device (also referred to as a networking device) may be embodied and/or described in terms of a computing device and vice-versa. However, it should further be understood that this description should in no way be construed so that claimed subject matter is limited to one embodiment, such as only a computing device and/or only a network device, but, instead, may be embodied as a variety of devices or combinations thereof, including, for example, one or more illustrative examples.

A network may also include now known, and/or to be later developed arrangements, derivatives, and/or improvements, including, for example, past, present and/or future mass storage, such as network attached storage (NAS), a storage area network (SAN), and/or other forms of device readable media, for example. A network may include a portion of the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures and/or may be substantially compliant and/or substantially compatible with differing protocols, such as network computing and/or communications protocols (e.g., network protocols), may interoperate within a larger network.

In the context of the present patent application, the term sub-network and/or similar terms, if used, for example, with respect to a network, refers to the network and/or a part thereof. Sub-networks may also comprise links, such as physical links, connecting and/or coupling nodes, so as to be capable to communicate signal packets and/or frames between devices of particular nodes, including via wired links, wireless links, or combinations thereof. Various types of devices, such as network devices and/or computing devices, may be made available so that device interoperability is enabled and/or, in at least some instances, may be transparent. In the context of the present patent application, the term “transparent,” if used with respect to devices of a network, refers to devices communicating via the network in which the devices are able to communicate via one or more intermediate devices, such as one or more intermediate nodes, but without the communicating devices necessarily specifying the one or more intermediate nodes and/or the one or more intermediate devices of the one or more intermediate nodes and/or, thus, may include within the network the devices communicating via the one or more intermediate nodes and/or the one or more intermediate devices of the one or more intermediate nodes, but may engage in signal communications as if such intermediate nodes and/or intermediate devices are not necessarily involved. For example, a router may provide a link and/or connection between otherwise separate and/or independent LANs.

In the context of the present patent application, a “private network” refers to a particular, limited set of devices, such as network devices and/or computing devices, able to communicate with other devices, such as network devices and/or computing devices, in the particular, limited set, such as via signal packet and/or signal frame communications, for example, without a need for re-routing and/or redirecting signal communications. A private network may comprise a stand-alone network; however, a private network may also comprise a subset of a larger network, such as, for example, without limitation, all or a portion of the Internet. Thus, for example, a private network “in the cloud” may refer to a private network that comprises a subset of the Internet. Although signal packet and/or frame communications (e.g. signal communications) may employ intermediate devices of intermediate nodes to exchange signal packets and/or signal frames, those intermediate devices may not necessarily be included in the private network by not being a source or designated destination for one or more signal packets and/or signal frames, for example. It is understood in the context of the present patent application that a private network may direct outgoing signal communications to devices not in the private network, but devices outside the private network may not necessarily be able to direct inbound signal communications to devices included in the private network.

The Internet refers to a decentralized global network of interoperable networks that comply with the Internet Protocol (IP). It is noted that there are several versions of the Internet Protocol. The term Internet Protocol, IP, and/or similar terms are intended to refer to any version, now known and/or to be later developed. The Internet includes local area networks (LANs), wide area networks (WANs), wireless networks, and/or long haul public networks that, for example, may allow signal packets and/or frames to be communicated between LANs. The term World Wide Web (WWW or Web) and/or similar terms may also be used, although it refers to a part of the Internet that complies with the Hypertext Transfer Protocol (HTTP). For example, network devices may engage in an HTTP session through an exchange of appropriately substantially compatible and/or substantially compliant signal packets and/or frames. It is noted that there are several versions of the Hypertext Transfer Protocol. The term Hypertext Transfer Protocol, HTTP, and/or similar terms are intended to refer to any version, now known and/or to be later developed. It is likewise noted that in various places in this document substitution of the term Internet with the term World Wide Web (“Web”) may be made without a significant departure in meaning and may, therefore, also be understood in that manner if the statement would remain correct with such a substitution.

Although claimed subject matter is not in particular limited in scope to the Internet and/or to the Web; nonetheless, the Internet and/or the Web may without limitation provide a useful example of an embodiment at least for purposes of illustration. As indicated, the Internet and/or the Web may comprise a worldwide system of interoperable networks, including interoperable devices within those networks. The Internet and/or Web has evolved to a public, self-sustaining facility accessible to potentially billions of people or more worldwide. Also, in an embodiment, and as mentioned above, the terms “WWW” and/or “Web” refer to a part of the Internet that complies with the Hypertext Transfer Protocol. The Internet and/or the Web, therefore, in the context of the present patent application, may comprise a service that organizes stored digital content, such as, for example, text, images, video, etc., through the use of hypermedia, for example. It is noted that a network, such as the Internet and/or Web, may be employed to store electronic files and/or electronic documents.

The term electronic file and/or the term electronic document are used throughout this document to refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

A Hyper Text Markup Language (“HTML”), for example, may be utilized to specify digital content and/or to specify a format thereof, such as in the form of an electronic file and/or an electronic document, such as a Web page, Web site, etc., for example. An Extensible Markup Language (“XML”) may also be utilized to specify digital content and/or to specify a format thereof, such as in the form of an electronic file and/or an electronic document, such as a Web page, Web site, etc., in an embodiment. Of course, HTML and/or XML are merely examples of “markup” languages, provided as non-limiting illustrations. Furthermore, HTML and/or XML are intended to refer to any version, now known and/or to be later developed, of these languages. Likewise, claimed subject matter are not intended to be limited to examples provided as illustrations, of course.

In the context of the present patent application, the term “Web site” and/or similar terms refer to Web pages that are associated electronically to form a particular collection thereof. Also, in the context of the present patent application, “Web page” and/or similar terms refer to an electronic file and/or an electronic document accessible via a network, including by specifying a uniform resource locator (URL) for accessibility via the Web, in an example embodiment. As alluded to above, in one or more embodiments, a Web page may comprise digital content coded (e.g., via computer instructions) using one or more languages, such as, for example, markup languages, including HTML and/or XML, although claimed subject matter is not limited in scope in this respect. Also, in one or more embodiments, application developers may write code (e.g., computer instructions) in the form of JavaScript (or other programming languages), for example, executable by a computing device to provide digital content to populate an electronic document and/or an electronic file in an appropriate format, such as for use in a particular application, for example. Use of the term “JavaScript” and/or similar terms intended to refer to one or more particular programming languages are intended to refer to any version of the one or more programming languages identified, now known and/or to be later developed. Thus, JavaScript is merely an example programming language. As was mentioned, claimed subject matter is not intended to be limited to examples and/or illustrations.

In the context of the present patent application, the terms “entry,” “electronic entry,” “document,” “electronic document,” “content,”, “digital content,” “item,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format). Likewise, in the context of the present patent application, digital content provided to a user in a form so that the user is able to readily perceive the underlying content itself (e.g., content presented in a form consumable by a human, such as hearing audio, feeling tactile sensations and/or seeing images, as examples) is referred to, with respect to the user, as “consuming” digital content, “consumption” of digital content, “consumable” digital content and/or similar terms. For one or more embodiments, an electronic document and/or an electronic file may comprise a Web page of code (e.g., computer instructions) in a markup language executed or to be executed by a computing and/or networking device, for example. In another embodiment, an electronic document and/or electronic file may comprise a portion and/or a region of a Web page. However, claimed subject matter is not intended to be limited in these respects.

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

Also, in the context of the present patent application, the term parameters (e.g., one or more parameters) refer to material descriptive of a collection of signal samples, such as one or more electronic documents and/or electronic files, and exist in the form of physical signals and/or physical states, such as memory states. For example, one or more parameters, such as referring to an electronic document and/or an electronic file comprising an image, may include, as examples, time of day at which an image was captured, latitude and longitude of an image capture device, such as a camera, for example, etc. In another example, one or more parameters relevant to digital content, such as digital content comprising a technical article, as an example, may include one or more authors, for example. Claimed subject matter is intended to embrace meaningful, descriptive parameters in any format, so long as the one or more parameters comprise physical signals and/or states, which may include, as parameter examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Signal packet communications and/or signal frame communications, also referred to as signal packet transmissions and/or signal frame transmissions (or merely “signal packets” or “signal frames”), may be communicated between nodes of a network, where a node may comprise one or more network devices and/or one or more computing devices, for example. As an illustrative example, but without limitation, a node may comprise one or more sites employing a local network address, such as in a local network address space. Likewise, a device, such as a network device and/or a computing device, may be associated with that node. It is also noted that in the context of this patent application, the term “transmission” is intended as another term for a type of signal communication that may occur in any one of a variety of situations. Thus, it is not intended to imply a particular directionality of communication and/or a particular initiating end of a communication path for the “transmission” communication. For example, the mere use of the term in and of itself is not intended, in the context of the present patent application, to have particular implications with respect to the one or more signals being communicated, such as, for example, whether the signals are being communicated “to” a particular device, whether the signals are being communicated “from” a particular device, and/or regarding which end of a communication path may be initiating communication, such as, for example, in a “push type” of signal transfer or in a “pull type” of signal transfer. In the context of the present patent application, push and/or pull type signal transfers are distinguished by which end of a communications path initiates signal transfer.

Thus, a signal packet and/or frame may, as an example, be communicated via a communication channel and/or a communication path, such as comprising a portion of the Internet and/or the Web, from a site via an access node coupled to the Internet or vice-versa. Likewise, a signal packet and/or frame may be forwarded via network nodes to a target site coupled to a local network, for example. A signal packet and/or frame communicated via the Internet and/or the Web, for example, may be routed via a path, such as either being “pushed” or “pulled,” comprising one or more gateways, servers, etc. that may, for example, route a signal packet and/or frame, such as, for example, substantially in accordance with a target and/or destination address and availability of a network path of network nodes to the target and/or destination address. Although the Internet and/or the Web comprise a network of interoperable networks, not all of those interoperable networks are necessarily available and/or accessible to the public.

In the context of the particular patent application, a network protocol, such as for communicating between devices of a network, may be characterized, at least in part, substantially in accordance with a layered description, such as the so-called Open Systems Interconnection (OSI) seven layer type of approach and/or description. A network computing and/or communications protocol (also referred to as a network protocol) refers to a set of signaling conventions, such as for communication transmissions, for example, as may take place between and/or among devices in a network. In the context of the present patent application, the term “between” and/or similar terms are understood to include “among” if appropriate for the particular usage and vice-versa. Likewise, in the context of the present patent application, the terms “compatible with,” “comply with” and/or similar terms are understood to respectively include substantial compatibility and/or substantial compliance.

A network protocol, such as protocols characterized substantially in accordance with the aforementioned OSI description, has several layers. These layers are referred to as a network stack. Various types of communications (e.g., transmissions), such as network communications, may occur across various layers. A lowest level layer in a network stack, such as the so-called physical layer, may characterize how symbols (e.g., bits and/or bytes) are communicated as one or more signals (and/or signal samples) via a physical medium (e.g., twisted pair copper wire, coaxial cable, fiber optic cable, wireless air interface, combinations thereof, etc.). Progressing to higher-level layers in a network protocol stack, additional operations and/or features may be available via engaging in communications that are substantially compatible and/or substantially compliant with a particular network protocol at these higher-level layers. For example, higher-level layers of a network protocol may, for example, affect device permissions, user permissions, etc.

A network and/or sub-network, in an embodiment, may communicate via signal packets and/or signal frames, such as via participating digital devices and may be substantially compliant and/or substantially compatible with, but is not limited to, now known and/or to be developed, versions of any of the following network protocol stacks: ARCNET, AppleTalk, ATM, Bluetooth, DECnet, Ethernet, FDDI, Frame Relay, HIPPI, IEEE 1394, IEEE 802.11, IEEE-488, Internet Protocol Suite, IPX, Myrinet, OSI Protocol Suite, QsNet, RS-232, SPX, System Network Architecture, Token Ring, USB, and/or X.25. A network and/or sub-network may employ, for example, a version, now known and/or later to be developed, of the following: TCP/IP, UDP, DECnet, NetBEUI, IPX, AppleTalk and/or the like. Versions of the Internet Protocol (IP) may include IPv4, IPv6, and/or other later to be developed versions.

Regarding aspects related to a network, including a communications and/or computing network, a wireless network may couple devices, including client devices, with the network. A wireless network may employ stand-alone, ad-hoc networks, mesh networks, Wireless LAN (WLAN) networks, cellular networks, and/or the like. A wireless network may further include a system of terminals, gateways, routers, and/or the like coupled by wireless radio links, and/or the like, which may move freely, randomly and/or organize themselves arbitrarily, such that network topology may change, at times even rapidly. A wireless network may further employ a plurality of network access technologies, including a version of Long Term Evolution (LTE), WLAN, Wireless Router (WR) mesh, 2nd, 3rd, or 4th generation (2G, 3G, 4G, or 5G) cellular technology and/or the like, whether currently known and/or to be later developed. Network access technologies may enable wide area coverage for devices, such as computing devices and/or network devices, with varying degrees of mobility, for example.

A network may enable radio frequency and/or other wireless type communications via a wireless network access technology and/or air interface, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, ultra-wideband (UWB), 802.11b/g/n, and/or the like. A wireless network may include virtually any type of now known and/or to be developed wireless communication mechanism and/or wireless communications protocol by which signals may be communicated between devices, between networks, within a network, and/or the like, including the foregoing, of course.

FIG. 9 is a schematic diagram illustrating an implementation of an example computing environment associated with processes to facilitate assigning, configuring and/or managing a particular hardware device, such as a ML accelerator and/or the like, according to an embodiment. In the example depicted in FIG. 9, a system embodiment may comprise a local network (e.g., device 904 and medium 940) and/or another type of network, such as a computing and/or communications network. For purposes of illustration, therefore, FIG. 9 shows an embodiment 900 of a system that may be employed to implement either type or both types of networks. Network 908 may comprise one or more network connections, links, processes, services, applications, and/or resources to facilitate and/or support communications, such as an exchange of communication signals, for example, between a computing device, such as 902, and another computing device, such as 906, which may, for example, comprise one or more client computing devices and/or one or more server computing device. By way of example, but not limitation, network 908 may comprise wireless and/or wired communication links, telephone and/or telecommunications systems, Wi-Fi networks, Wi-MAX networks, the Internet, a local area network (LAN), a wide area network (WAN), or any combinations thereof.

Example devices in FIG. 9 may comprise features, for example, of a client computing device and/or a server computing device, in an embodiment. It is further noted that the term computing device, in general, whether employed as a client and/or as a server, or otherwise, refers at least to a processor and a memory connected by a communication bus. A “processor,” for example, is understood to connote a specific structure such as a central processing unit (CPU) of a computing device which may include a control unit and an execution unit. In an aspect, a processor may comprise a device that interprets and executes instructions to process input signals to provide output signals. As such, in the context of the present patent application at least, computing device and/or processor are understood to refer to sufficient structure within the meaning of 35 USC § 112 (f) so that it is specifically intended that 35 USC § 112 (f) not be implicated by use of the term “computing device,” “processor” and/or similar terms; however, if it is determined, for some reason not immediately apparent, that the foregoing understanding cannot stand and that 35 USC § 112 (f), therefore, necessarily is implicated by the use of the term “computing device,” “processor” and/or similar terms, then, it is intended, pursuant to that statutory section, that corresponding structure, material and/or acts for performing one or more functions be understood and be interpreted to be described at least in FIGS. 1-7 and in the text associated with the foregoing figure(s) of the present patent application.

Referring now to FIG. 9, in an embodiment, first and third devices 902 and 906 may be capable of rendering a graphical user interface (GUI) for a network device and/or a computing device, for example, so that a user-operator may engage in system use. Device 904 may potentially serve a similar function in this illustration. Likewise, in FIG. 9, computing device 902 (‘first device’ in figure) may interface with computing device 904 (‘second device’ in figure), which may, for example, also comprise features of a client computing device and/or a server computing device, in an embodiment. Processor (e.g., processing device) 920 and memory 922, which may comprise primary memory 924 and secondary memory 926, may communicate by way of a communication bus 915, for example. The term “computing device,” in the context of the present patent application, refers to a system and/or a device, such as a computing apparatus, that includes a capability to process (e.g., perform computations) and/or store digital content, such as electronic files, electronic documents, measurements, text, images, video, audio, etc. in the form of signals and/or states. Thus, a computing device, in the context of the present patent application, may comprise hardware, software, firmware, or any combination thereof (other than software per se). Computing device 904, as depicted in FIG. 9, is merely one example, and claimed subject matter is not limited in scope to this particular example.

For one or more embodiments, a device, such as a computing device and/or networking device, may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, Internet of Things (IOT) type devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D or 3D display, for example.

As suggested previously, communications between a computing device and/or a network device and a wireless network may be in accordance with known and/or to be developed network protocols including, for example, global system for mobile communications (GSM), enhanced data rate for GSM evolution (EDGE), 802.11b/g/n/h, etc., and/or worldwide interoperability for microwave access (WiMAX). A computing device and/or a networking device may also have a subscriber identity module (SIM) card, which, for example, may comprise a detachable or embedded smart card that is able to store subscription content of a user, and/or is also able to store a contact list. It is noted, however, that a SIM card may also be electronic, meaning that is may simply be stored in a particular location in memory of the computing and/or networking device. A user may own the computing device and/or network device or may otherwise be a user, such as a primary user, for example. A device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a computing and/or communications network may be embodied as a wired network, wireless network, or any combinations thereof.

A computing and/or network device may include and/or may execute a variety of now known and/or to be developed operating systems, derivatives and/or versions thereof, including computer operating systems, such as Windows, iOS, Linux, a mobile operating system, such as iOS, Android, Windows Mobile, and/or the like. A computing device and/or network device may include and/or may execute a variety of possible applications, such as a client software application enabling communication with other devices. For example, one or more messages (e.g., content) may be communicated, such as via one or more protocols, now known and/or later to be developed, suitable for communication of email, short message service (SMS), and/or multimedia message service (MMS), including via a network, such as a social network, formed at least in part by a portion of a computing and/or communications network, including, but not limited to, Facebook, LinkedIn, Twitter, and/or Flickr, to provide only a few examples. A computing and/or network device may also include executable computer instructions to process and/or communicate digital content, such as, for example, textual content, digital multimedia content, and/or the like. A computing and/or network device may also include executable computer instructions to perform a variety of possible tasks, such as browsing, searching, playing various forms of digital content, including locally stored and/or streamed video, and/or games such as, but not limited to, fantasy sports leagues. The foregoing is provided merely to illustrate that claimed subject matter is intended to include a wide range of possible features and/or capabilities.

In FIG. 9, computing device 902 may provide one or more sources of executable computer instructions in the form physical states and/or signals (e.g., stored in memory states), for example. Computing device 902 may communicate with computing device 904 by way of a network connection, such as via network 908, for example. As previously mentioned, a connection, while physical, may not necessarily be tangible. Although computing device 904 of FIG. 9 shows various tangible, physical components, claimed subject matter is not limited to a computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 922 may comprise any non-transitory storage mechanism. Memory 922 may comprise, for example, primary memory 924 and secondary memory 926, additional memory circuits, mechanisms, or combinations thereof may be used. Memory 922 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 922 may be utilized to store a program of executable computer instructions. For example, processor 920 may fetch executable instructions from memory and proceed to execute the fetched instructions. Memory 922 may also comprise a memory controller for accessing device readable-medium 940 that may carry and/or make accessible digital content, which may include code, and/or instructions, for example, executable by processor 920 and/or some other device, such as a controller, as one example, capable of executing computer instructions, for example. Under direction of processor 920, a non-transitory memory, such as memory cells storing physical states (e.g., memory states), comprising, for example, a program of executable computer instructions, may be executed by processor 920 and able to generate signals to be communicated via a network, for example, as previously described. Generated signals may also be stored in memory, also previously suggested.

Memory 922 may store electronic files and/or electronic documents, such as relating to one or more users, and may also comprise a computer-readable medium that may carry and/or make accessible content, including code and/or instructions, for example, executable by processor 920 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present patent application, and generally, is considered to be a self-consistent sequence of operations and/or similar signal processing leading to a desired result. In the context of the present patent application, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

It has proven convenient at times, principally for reasons of common usage, to refer to such physical signals and/or physical states as bits, values, elements, parameters, symbols, characters, terms, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computer and/or similar special purpose computing and/or network device. In the context of this particular patent application, as mentioned, the term “specific apparatus” therefore includes a general purpose computing and/or network device, such as a general purpose computer, once it is programmed to perform particular functions, such as pursuant to program software instructions.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state from a binary one to a binary zero or vice-versa in a memory device may comprise a transformation, such as a physical, but non-transitory, transformation. Rather, the foregoing is intended as illustrative examples.

Referring again to FIG. 9, processor 920 may comprise one or more circuits, such as digital circuits, to perform at least a portion of a computing procedure and/or process. By way of example, but not limitation, processor 920 may comprise one or more processors, such as controllers, microprocessors, microcontrollers, application specific integrated circuits, digital signal processors, programmable logic devices, field programmable gate arrays, the like, or any combination thereof. In various implementations and/or embodiments, processor 920 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 9 also illustrates device 904 as including a component 932 operable with input/output devices, for example, so that signals and/or states may be appropriately communicated between devices, such as device 904 and an input device and/or device 904 and an output device. A user may make use of an input device, such as a computer mouse, stylus, track ball, keyboard, and/or any other similar device capable of receiving user actions and/or motions as input signals. Likewise, for a device having speech to text capability, a user may speak to a device to generate input signals. A user may make use of an output device, such as a display, a printer, etc., and/or any other device capable of providing signals and/or generating stimuli for a user, such as visual stimuli, audio stimuli and/or other similar stimuli.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A method, comprising:
establishing, utilizing a processor of a computing device, a connection between a first application pod running at the computing device and a machine learning inference pod running at an edge node, wherein the first application pod comprises signals and/or states representative of a first software application and a machine learning model; and
utilizing the processor of the computing device, allowing the machine learning inference pod to load the machine learning model from the first application pod and to enable the machine learning inference pod to perform an inference operation based at least in part on the machine learning model.

2. The method of claim 1, wherein the allowing the machine learning inference pod to load the machine learning model from the first application pod includes allowing the machine learning inference pod to load the machine learning model over a reverse mount of a local file namespace for the first application pod.

3. The method of claim 1, wherein the allowing the machine learning inference pod to load the machine learning model from the first application pod includes allowing the machine learning inference pod running at the edge node to access a local namespace from the first application pod.

4. The method of claim 3, wherein the machine learning model comprises a serialized machine learning model and wherein, to load the machine learning model from the first application pod, the machine learning inference pod to deserialize the machine learning model directly from the first application pod and to store the deserialized machine learning model in a memory allocated to the machine learning inference pod without storing the machine learning model in a cloud storage and without storing the machine learning model in a local model storage.

5. The method of claim 4, wherein the allowing the machine learning inference pod to load the machine learning model from the first application pod includes performing a hashing algorithm on the machine learning model prior to deserialization at least in part to prevent duplicate machine learning models from stored in the memory allocated to the machine learning inference pod.

6. The method of claim 1, wherein the machine learning inference pod comprises one or more application programming interfaces and an inference engine.

7. The method of claim 6, wherein the edge node to perform the inference operation at least in part by executing the inference engine.

8. The method of claim 7, wherein the edge node to execute the inference engine at least in part by establishing a connection with a cloud-based inference service to have the inference operation performed, at least in part, by the cloud-based inference service.

9. The method of claim 1, wherein the establishing the connection between the first application pod and the machine learning inference pod comprises establishing the connection at least in part in accordance with a hypertext transport protocol (HTTP) and/or at least in part in accordance with a remote procedure call framework.

10. The method of claim 1, further comprising:
establishing one or more additional connections between one or more additional application pods and the machine learning inference pod; and
allowing the machine learning inference pod to directly access one or more additional machine learning models pertaining respectively to the one or more additional application pods, wherein the machine learning inference pod to prevent the first software application from accessing the one or more additional machine learning models and also to prevent one or more additional software applications pertaining respectively to the one or more additional application pods from accessing the machine learning model of the first application pod.

11. An apparatus, comprising:
a processor to:
establish a connection between a first application pod running on the processor and a machine learning inference pod running at an edge node, wherein the first application pod to comprise signals and/or states representative of a first software application and a machine learning model;
allow the machine learning inference pod to load the machine learning model from the first application pod; and
enable the machine learning inference pod to perform an inference operation based at least in part on the machine learning model.

12. The apparatus of claim 11, wherein, to allow the machine learning inference pod to load the machine learning model from the first application pod, the processor to allow the machine learning inference pod to load the machine learning model over a reverse mount of a local file namespace for the first application pod.

13. The apparatus of claim 11, wherein, to allow the machine learning inference pod to load the machine learning model from the first application pod, the processor to allow the machine learning inference pod running at the edge node to access a local namespace from the first application pod.

14. The apparatus of claim 13, wherein the machine learning model comprises a serialized machine learning model and wherein, to load the machine learning model from the first application pod, the machine learning inference pod to deserialize the first machine learning model directly from the first application pod and store the deserialized first machine learning model in a memory allocated to the machine learning inference pod without storing the first machine learning model in a cloud storage and without storing the first machine learning model in a local model storage.

15. The apparatus of claim 11, wherein the machine learning inference pod comprises one or more application programming interfaces and an inference engine.

16. The apparatus of claim 15, wherein, to perform the inference operation, the edge node to execute the inference engine.

17. The apparatus of claim 16, wherein, to execute the inference engine, the edge node to establish a connection with a cloud-based inference service to have the inference operation performed, at least in part, by the cloud-based inference service.

18. The apparatus of claim 11, wherein, to establish the connection between the first application pod and the machine learning inference pod, the processor to establish the connection at least in part in accordance with a hypertext transport protocol (HTTP) and/or a remote procedure call framework.

19. The apparatus of claim 11, wherein the processor further to:
establish one or more additional connections between one or more additional application pods and the machine learning inference pod; and
allow the machine learning inference pod to directly access one or more additional machine learning models to pertain respectively to the one or more additional application pods, wherein the machine learning inference pod to prevent the first software application from accessing the one or more additional machine learning models and also to prevent one or more additional software applications pertaining respectively to the one or more additional application pods from accessing the machine learning model of the first application pod.

20. An article, comprising: a non-transitory computer-readable medium having stored thereon one or more instructions executable by a computing device to:
establish a connection between a first application pod running on the computing device and a machine learning inference pod running at an edge node, wherein the first application pod to comprise signals and/or states representative of a first software application and a machine learning model;
allow the machine learning inference pod to load the machine learning model from the first application pod; and
enable the machine learning inference pod to perform an inference operation based at least in part on the machine learning model.
